(19) United States
(12) Patent Application Publication
(10) Pub. No.: US 2025/0007765 A1
(43) Pub. Date: Jan. 2, 2025

(54) TRANSFORM-PRECODING OF A SELECTIVE SET OF DATA FOR TRANSMISSION OVER A WIRELESS COMMUNICATION NETWORK

(71) Applicants: Centre of Excellence in Wireless Technology, Chennai, Tamil Nadu (IN); Indian Institute of Technology Madras (IIT Madras), Chennai, Tamil Nadu (IN)

(72) Inventors: Dhivagar Baskaran, Chennai, Tamil Nadu (IN); Vishakha Singh, Chennai, Tamil Nadu (IN); Thirunageswaram Ramachandran Ramya, Chennai, Tamil Nadu (IN); Jeniston Deviraj Klutto Milleth, Chennai, Tamil Nadu (IN); Bhaskar Ramamurthi, Chennai, Tamil Nadu (IN)

(21) Appl. No.: 18/709,408

(22) PCT Filed: Nov. 10, 2022
(86) PCT No.: PCT/IN2022/050984

§ 371 Date: May 10, 2024

(30) Foreign Application Priority Data
Nov. 12, 2021 (IN) 202141052050

(51) Int. Cl. H04L 27/26; H04L 5/00; H04W 72/044

(52) U.S. Cl. CPC H04L 27/2615; H04L 5/0016; H04L 27/26526; H04W 72/044

(57) ABSTRACT

A system (102) and method (200) of processing a bit stream for transmission over a wireless communication network (100) is described. The method comprises mapping, by a transmitting node (102), a bit stream to obtain at least one modulation symbol. A set of modulation symbols may be selected from the at least one modulation symbol based on one or more predefined precoding criteria, for enabling transform-precoding of the set of modulation symbols. The transform-precoding of the set of modulation symbols may be performed to obtain precoded symbols.

### FIELD OF THE INVENTION

The present invention relates to wireless communication systems, and more particularly to a method of performing transform-precoding of data to be transmitted over a wireless communication network.

### BACKGROUND OF THE INVENTION

Wireless communication is widely used for transmission of data from one place to another. The wireless communication at higher frequency bands (such as GHz/THz frequencies) faces several challenges compared to the wireless communication at lower frequency bands. The challenges associated with the higher frequency bands are higher Phase Noise (PN), extreme propagation loss, high atmospheric absorption in certain frequencies, lower power amplifier efficiency, and strict transmitted power spectral density regulatory requirements.

One of the prominent challenges associated with the higher frequency bands is the efficient utilization of a Power Amplifier (PA) used for amplifying power of signal for transmission using the wireless communication. The signal with high Peak to Average Power ratio (PAPR) requires the PA to be highly linear. An overall cost for managing the PA increases exponentially for increase in power utilization in the wireless communication. To reduce the overall cost for managing the PA, a signal with low PAPR can be operated closer to a saturation region. Therefore, a waveform with a low PAPR is required for efficient utilization of the PA. Additionally, higher carrier frequencies used in the wireless communication have less coverage area due to undesirable propagation characteristics of the wireless channel at higher frequencies.

The waveform adopted in 3GPP standards is Cyclic Prefixed Orthogonal Frequency Division Multiplexing (CP-OFDM). The CP-OFDM is composed of superposition of multiple signals transmitted using narrowband orthogonal subcarriers. However, the superposition of multiple signals results in higher PAPR values. For reducing the PAPR values, the multiple signals are converted into a single carrier waveform. To convert the multiple signals into the single carrier waveform, transform-precoding is used in 3GPP Long Term Evolution (LTE) and the New Radio (NR) standards. However, the signals transmitted using transform-precoding is more affected by interference as compared to the CP-OFDM and leads to reduction in performance.

Hence, there is a need for a cost-effective technique to reduce the PAPR and interference in order to efficiently utilize the PA in CP-OFDM based wireless communication networks.

### OBJECTS OF THE INVENTION

A general objective of the present invention is to provide a method for performing transform-precoding of a set of modulation symbols for transmission over a wireless communication network.

Another objective of the present invention is to provide techniques for efficient utilization of power amplifier by reducing a PAPR of the waveform.

Yet another objective of the present invention is to mitigate challenges faced in wireless communication using higher frequency bands (such as GHz/THz frequencies).

Still another objective of the present invention is to enhance performance of a carrier waveform used in wireless communication.

### SUMMARY OF THE INVENTION

This summary is provided to introduce aspects related to the method of processing a bit stream for transmission over a wireless communication network, and the aspects are further described below in the detailed description. This summary is neither intended to identify essential features of the claimed subject matter nor is it intended for use in determining or limiting the scope of the claimed subject matter.

The present disclosure proposes a method of processing a bit stream for transmission over a wireless communication network. The method may comprise mapping, by a transmitting node, a bit stream to obtain at least one modulation symbol. A set of modulation symbols may be selected from the at least one modulation symbol based on at least one predefined precoding criteria. A transform-precoding may be enabled for the set of modulation symbols. The transform-precoding of the set of modulation symbols may be performed to obtain precoded symbols for modulation and transmission.

In an aspect, the at least one precoded and non-precoded symbols may be mapped to virtual resource elements of each antenna port of the transmitting node. The virtual resource elements of each antenna port may be mapped to physical resource blocks for transmission of the at least one precoded and non-precoded symbols over the wireless communication network.

In an aspect, an Inverse Fast Fourier transform (IFFT) operation may be performed over the precoded symbols and non-precoded symbols present in the physical resource blocks.

In an aspect, a Cyclic Prefix (CP) may be added after the IFFT operation of the precoded symbols and the non-precoded symbols.

In an aspect, wherein the at least one predefined precoding criteria may be obtained by selecting the set of modulated symbols based on at least one of a modulation order, a physical channel, a physical signal and one of an Orthogonal Frequency Division Multiplexing (OFDM) symbol index, slot index, sub frame index, and frame index within a time window.

In an aspect, the transform-precoding may be implemented using at least one of Discrete Fourier Transformation (DFT), Symplectic Finite Fourier Transform (SFFT), Inverse Discrete Fourier Transformation (IDFT), and Inverse Symplectic Finite Fourier Transform (ISFFT).

In an aspect, a precoding information indicative of the precoded symbols may be transmitted through at least one of Radio Resource Control (RRC) signaling, Medium Access Control-Control Element (MAC-CE) signaling, and Downlink Control Information (DCI) signaling.

In an aspect, an inverse transform-precoding of the precoded symbols is performed to obtain the set of modulation symbols.

Further, the present disclosure proposes a method of processing of symbols after reception over a wireless communication network. The method may comprise de-mapping, by a receiving node, symbols of at least one antenna port of the receiving node. The precoded symbols are selected based on a precoding information received from the transmitting node and inverse-transform-precoding of the precoded symbols is performed to obtain a set of modulation symbols.

In an aspect, a Cyclic Prefix (CP) may be removed, and Fast Fourier Transform (FFT) may be performed, after reception of the precoded symbols and the non-precoded symbols.

Further, the present disclosure proposes a system for processing a bit stream for transmission over a wireless communication network. The system may comprise a processor and a memory coupled with the processor. The memory may store processor-executable instructions. The processor-executable instructions may be executed by the processor to map a bit stream to obtain at least one modulation symbol. A set of modulation symbols may be selected from the at least one modulation symbol based on at least one predefined precoding criteria. the at least one predefined precoding criteria is obtained by selecting the set of modulated symbols based on at least one of a modulation order, a physical channel, a physical signal and one of an Orthogonal Frequency Division Multiplexing (OFDM) symbol index, slot index, sub frame index, and frame index within a time window. The processor-executable instructions may be further executed by the processor to perform the transform-precoding of the set of modulation symbols to obtain precoded symbols for modulation and transmission.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

FIG. 1 illustrates an implementation diagram of a wireless communication network, in accordance with an embodiment of the present invention.

FIG. 2 illustrates a flow chart of a method of processing a bit stream for transmission over a wireless communication network, in accordance with an embodiment of the present invention.

FIG. 3 illustrates a flow chart of a method of processing modulation symbols after reception over a wireless communication network, in accordance with an embodiment of the present invention.

FIG. 4 illustrates a time-frequency plot of modulation symbols used as a first precoding criteria, in accordance with an embodiment of the present invention.

FIG. 5 illustrates a time-frequency plot of Modulation and Coding Schemes (MCSs) used as a second precoding criteria, in accordance with an embodiment of the present invention.

FIG. 6 illustrates a time-frequency plot of Physical Channels/Signals used as a third precoding criteria, in accordance with an embodiment of the present invention.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

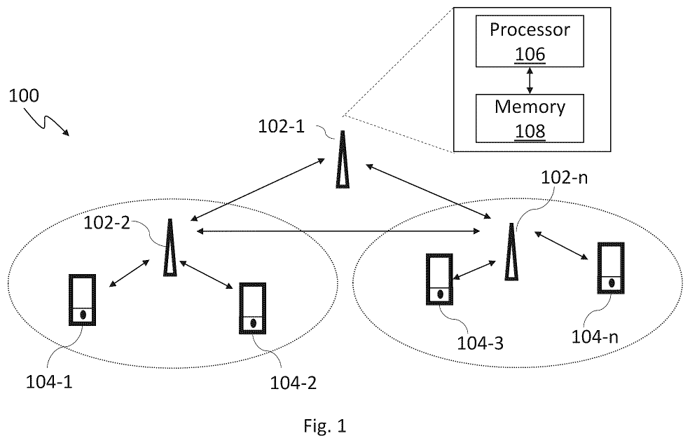

FIG. 1 illustrates an implementation diagram of a wireless communication network 100, in accordance with an embodiment of the present invention. The wireless communication network 100 comprises a plurality of base stations (BS) such as a first BS (102-1), a second BS (102-2) through n^{th} BS (102-n). The wireless communication network 100 further comprises a plurality of user equipments (UEs) such as a first UE (104-1), a second UE (104-2), a third UE (104-3) through n^{th} UE (104-n). All the BSs (102-1 through 102-n) are cumulatively referred as a BS 102 for the ease of labelling and explanation. Similarly, all the UEs (104-1 through 104-n) are cumulatively referred as a UE 104 for the ease of labelling and explanation. The BS 102 may also be referred as a transmitting node and the UE 104 may also be referred as a receiving node.

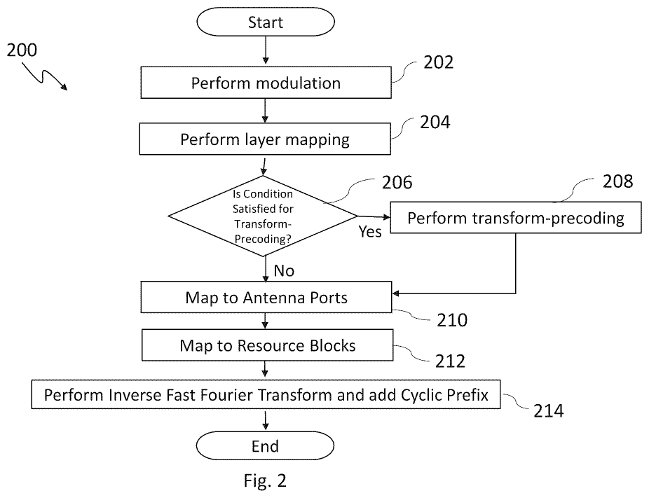

The BS 102 may have a predefined coverage area for serving the UE 104. In one scenario, the first UE (104-1) and the second UE (104-2) may be present in a coverage area of the second BS (102-2). Further, the third UE (104-3) and the n^{th} UE (104-n) may be present in a coverage area of the n^{th} BS (102-n). The BS 102 may communicate with each other for coordinating and communicating with the UE 104. The UE 104 may be dispersed throughout the wireless communication network 100 and the UE 104 may be either stationary or mobile. Each of the BS 102 includes a processor 106 and a memory 108. The processor 106 may be communicatively coupled with the memory 108. The memory 108 may store processor-executable instructions. The instructions may be executed by the processor 108 to perform a method described with reference to FIG. 2.

The present invention relates to a method and apparatus of processing a bit stream for transmission over the wireless communication network 100. FIG. 2 illustrates a flow chart 200 of processing a bit stream for transmission over a wireless communication network, in accordance with an embodiment of the present invention. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 2 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

A bit stream may be received for transmission over the wireless communication network 100. The bit stream may be modulated to obtain one or more modulation symbols, at step 202. Examples of the modulation performed on the bit stream may include, but not limited to, Binary Phase Shift Keying (BPSK), Quadrature Phase Shift Keying (QPSK), and Quadrature Amplitude Modulation (QAM). The one or more modulation symbols may be mapped to each transmission layer of a plurality of transmission layers, at step 204. The mapping may be performed for distribution of the one or more modulation symbols across different transmission layers. A number of the plurality of layers may depends upon a number of antenna ports available for transmission of a signal.

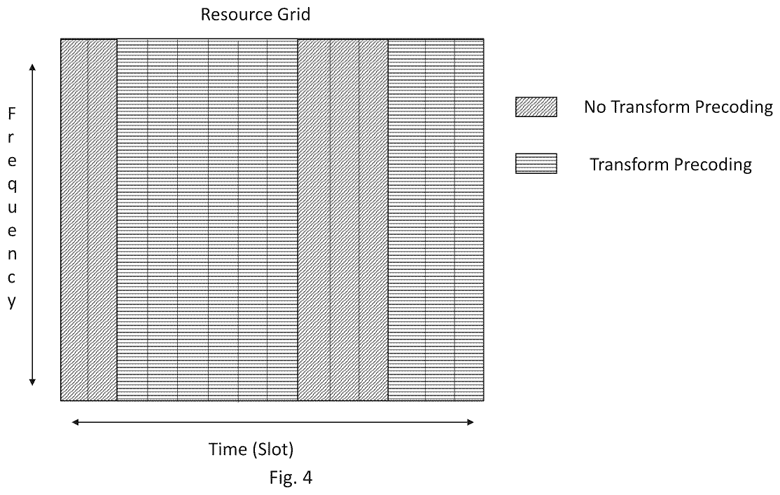

One or more predefined precoding criteria may be applied on each modulation symbol of the at least one modulation symbols to select a set of modulation symbols, at step 206. The at least one predefined precoding criteria may be used for determining whether a modulation symbol is appropriate for performing transform-precoding. The at least one predefined precoding criteria may be described in detail with reference to FIGS. 4 through 6.

The set of modulation symbols may satisfy the at least one predefined precoding criteria. The transform-precoding of the set of modulation symbols may be performed to obtain precoded symbols, at step 208. Examples of the transform-precoding may include a unitary transformation, such as Discrete Fourier Transformation (DFT), Symplectic Finite Fourier Transform (SFFT), Inverse Discrete Fourier Transformation (IDFT), and Inverse Symplectic Finite Fourier Transform (ISFFT).

The precoded symbols and non precoded symbols of the at least one modulation symbol may be mapped to virtual resource blocks of the antenna ports, at step 210. For example, the plurality of transmission layers may be mapped to a set of antenna ports. Further, the virtual resource blocks of the antenna ports may be mapped to corresponding physical resource blocks, at step 212. The one or more modulation symbols may be mapped to a set of available resource elements in the physical resource blocks. The precoded symbols and non precoded symbols of at least one modulation symbol may be transformed to OFDM symbols using Inverse Fast Fourier Transform (IFFT) and a Cyclic Prefix (CP) may be added to the OFDM symbols to obtain CP-OFDM symbols, at step 214. The CP-OFDM symbols may be transmitted over the wireless communication network 100. In one implementation, the CP-OFDM symbols may be transmitted to the UE 104 in a form of a waveform.

Further, a precoding information indicative of the precoded symbols may be provided to the UE 104. The precoding information may be provided to the UE 104 through at least one of Radio Resource Control (RRC) signaling, Medium Access Control-Control Element (MAC-CE), and Downlink Control Information (DCI) signaling.

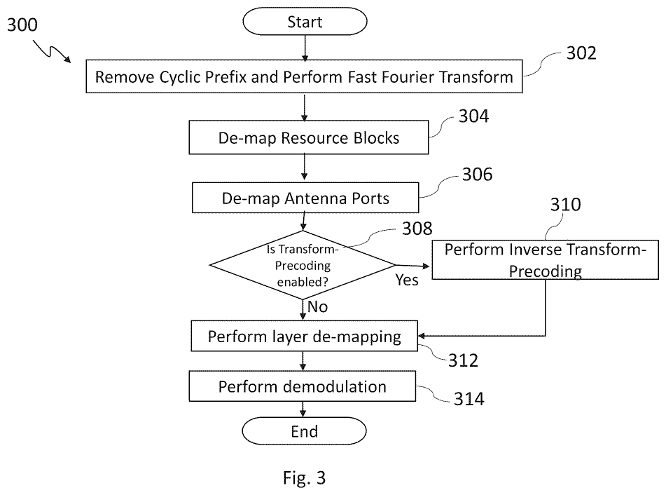

FIG. 3 illustrates a flow chart 300 receiving and processing one or more signals over a wireless communication network, in accordance with an embodiment of the present invention. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 3 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved.

CP-OFDM symbols may be received from the BS 102 in form of a waveform. A Cyclic Prefix (CP) may be removed and Fast Fourier transform (FFT) may be performed on the received CP-OFDM symbols, at step 302. Further, virtual resource elements may be de-mapped from physical resource blocks of each antenna port, at step 304. For example, a signal may be extracted from the physical resource blocks. The plurality of transmission layers may be de-mapped from the virtual resource elements of each antenna port, at step 306.

Precoded symbols may be selected, at step 308. The precoded symbols was obtained by performing the transform-precoding of a set of symbols. A precoding information received from the BS 102 may be used for selection of the precoded symbols. The precoding information may be received from the BS 102 through at least one of Radio Resource Control (RRC) signaling, Medium Access Control-Control Element (MAC-CE), and Downlink Control Information (DCI) signaling.

The inverse transform-precoding of the precoded symbols may be performed to obtain inverse precoded symbols, at step 310. Examples of the inverse transform-precoding may include, but not limited to, Inverse Discrete Fourier Transformation (IDFT), Inverse Symplectic Finite Fourier Transform (ISFFT), and any other inverse unitary transformation.

The inverse precoded symbols and non-precoded symbols may be de-mapped from a plurality of layers, at step 312. For example, the signal extracted from the physical resource blocks may be combined with the plurality of transmission layers to generate a collective signal. Further, the collective signal may be de-modulated to obtain a bit stream, at step 314.

FIGS. 4 through 6 illustrate one or more predefined precoding criteria for selection a set of modulation symbols enabled for transform-precoding. FIG. 4 illustrates a time-frequency plot of modulation symbols used as a first precoding criteria, in accordance with an embodiment of the present invention. In the first precoding criteria, such as an OFDM symbol based precoding criteria, a set of modulation symbols may be selected from at least one modulation symbols based on a symbol index within a time slot, a slot index, a sub frame index, or a frame index in which data traverses.

The OFDM symbol based precoding criteria may be configured by the BS 102. The set of modulation symbols is selected based on PAPR of the OFDM symbols. Transform-precoding may be performed on an entire frequency resource and selected OFDM symbols of the slot used for transmission. In one implementation, the transform-precoding of a set of modulated symbols is performed in OFDM-symbol indices 3-8 and 12-14, as illustrated in FIG. 4.

A precoding information indicating the selected time slot on which the transform-precoding is performed, may be transmitted to the UE 104. In one implementation, the precoding information may be transmitted to the UE 104 using at least one of RRC signaling, MAC-CE signaling, and DCI signaling. The precoding information may be used by the UE 104 for selecting precoded symbols in order to perform inverse transform-precoding.

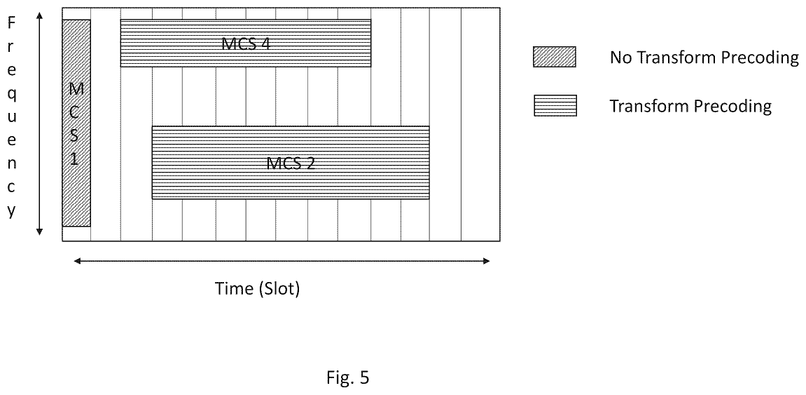

FIG. 5 illustrates a time-frequency plot of Modulation and Coding Schemes (MCSs) used as a second precoding criteria, in accordance with an embodiment of the present invention. In the second precoding criteria, a set of modulation symbols may be selected from at least one modulation symbols based on the PAPR of a modulation order. The modulation order may be different for different modulation schemes, such as BPSK, QPSK, and QAM. Table 1 represents various modulation schemes according to their modulation order.

TABLE 1
Modulation Schemes and Modulation Order

| Modulation scheme | Modulation order |
|---|---|
| π/2-BPSK | 1 |
| QPSK | 2 |
| 16-QAM | 3 |
| 64-QAM | 4 |
| 256-QAM | 5 |

As illustrated in FIG. 5, a set of modulated symbols in OFDM-symbol indices 4-12 was transform-precoded based on the modulation order 2 and a set of modulated symbols in OFDM-symbol indices 3-10 was transform-precoded based on the modulation order 4. A precoding information indicating the selected modulation order on which the transform-precoding is performed, may be transmitted to the UE 104. In one implementation, the precoding information may be transmitted to the UE 104 using at least one of RRC signaling, MAC-CE signaling, and DCI signaling. The precoding information may be used by the UE 104 for selecting a set of received modulated symbols in order to perform inverse transform-precoding.

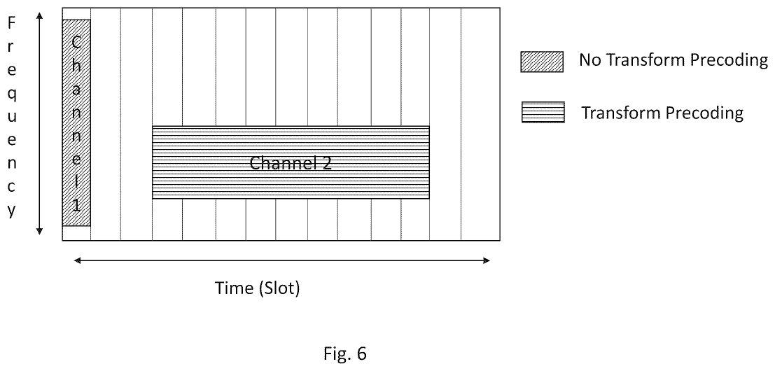

FIG. 6 illustrates a time-frequency plot of Physical Channels/Signals used as a third precoding criteria, in accordance with an embodiment of the present invention. In the third precoding criteria, a set of modulated symbols may be selected based on the PAPR of physical channel or signal. As illustrated in FIG. 6, the transform-precoding of the set of modulated symbols in OFDM-symbol indices 4-12 may be performed based on a type of channel such as channel 2 that differs from a channel such as channel 1 used in OFDM-symbol index 1.

A precoding information indicative of the precoded symbols, may be transmitted to the UE 104. In one implementation, the precoding information may be transmitted to the UE 104 using at least one of RRC signaling, MAC-CE signaling, and DCI signaling. The precoding information may be used by the UE 104 for selecting a set of modulation symbols in order to perform inverse transform-precoding.

As described in one or more embodiments of present invention, a portion of available bandwidth may be used for transmitting CP-OFDM symbols without performing transform-precoding and another portion of the available bandwidth may be used for transmitting the CP-OFDM symbol after performing the transform-precoding. Thus, a selective set of modulation symbols may be transform-precoded in combination with CP-OFDM signal. In addition, performing the transform-precoding of the selected modulation symbols leads to reducing power consumption of the PA in CP-OFDM based wireless communication networks.

The present invention provides techniques for efficient utilization of power amplifier by reducing a PAPR. Also, the present invention provides techniques to perform transform-precoding of a selective set of data in combination with CP-OFDM, in order to reduce interference in multi access scenarios.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method (200) of processing a bit stream for transmission over a wireless communication network (100), the method (200) comprising:
mapping, by a transmitting node (102), a bit stream to obtain at least one modulation symbol;
selecting, by the transmitting node (102), a set of modulation symbols from the at least one modulation symbol based on at least one predefined precoding criteria, for enabling transform-precoding of the set of modulation symbols; and
performing, by the transmitting node (102), the transform-precoding of the set of modulation symbols to obtain precoded symbols for modulation and transmission.

2. The method (200) as claimed in claim 1, further comprising:
performing, by the transmitting node (102), an Inverse Fast Fourier transform (IFFT) operation to the precoded symbols and non-precoded symbols of the at least one modulation symbols; and
transmitting, by the transmitting node (102), the precoded symbols and the non-precoded symbols over the wireless communication network (100).

3. The method (200) as claimed in claim 1, wherein the at least one predefined precoding criteria is obtained by selecting the set of modulated symbols based on at least one of a modulation order, a physical channel, a physical signal and one of an Orthogonal Frequency Division Multiplexing (OFDM) symbol index, slot index, sub frame index, and frame index within a time window.

4. The method (200) as claimed in claim 2,
wherein the at least one precoded and non-precoded symbols are mapped to virtual resource elements of each antenna port of the transmitting node (102), and
wherein the virtual resource elements of each antenna port are mapped to physical resource blocks for transmission of the at least one precoded and non-precoded symbols.

5. The method (200) as claimed in claim 2, wherein a Cyclic Prefix (CP) is added after the IFFT operation of the precoded symbols and the non-precoded symbols.

6. The method (200) as claimed in claim 1, wherein the transform-precoding is implemented using at least one of Discrete Fourier Transformation (DFT), Symplectic Finite Fourier Transform (SFFT), Inverse Discrete Fourier Transformation (IDFT), and Inverse Symplectic Finite Fourier Transform (ISFFT).

7. The method (200) as claimed in claim 1, wherein a precoding information indicative of the precoded symbols is transmitted through at least one of Radio Resource Control (RRC) signaling, Medium Access Control-Control Element (MAC-CE) signaling, and Downlink Control Information (DCI) signaling.

8. A method (300) of processing of symbols after reception over a wireless communication network (100), the method (300) comprising:
de-mapping, by a receiving node (104), symbols of at least one antenna port of the receiving node (104);
selecting, by the receiving node (104), the precoded symbols based on a precoding information received from the transmitting node (102); and
performing, by the receiving node (104), inverse-transform-precoding of the precoded symbols to obtain a set of modulation symbols.

9. The method (300) as claimed in claim 8, wherein a Cyclic Prefix (CP) is removed and Fast Fourier Transform (FFT) is performed, after reception of the precoded symbols and the non-precoded symbols.

10. A system (102) for processing a bit stream for transmission over a wireless communication network, the system comprising:
a processor (106); and
a memory (108) coupled with the processor, wherein the memory (108) stores processor-executable instructions, which when executed by the processor (106), causes the processor (106) to:
map a bit stream to obtain at least one modulation symbol;
select a set of modulation symbols from the at least one modulation symbol based on at least one predefined precoding criteria, for enabling transform-precoding of the set of modulation symbols, wherein the at least one predefined precoding criteria is obtained by selecting the set of modulated symbols based on at least one of a modulation order, a physical channel, a physical signal and one of an Orthogonal Frequency Division Multiplexing (OFDM) symbol index, slot index, sub frame index, and frame index within a time window; and
perform the transform-precoding of the set of modulation symbols to obtain precoded symbols for modulation and transmission.
